(19) United States
(12) Patent Application Publication
(10) Pub. No.: US 2024/0373153 A1
(43) Pub. Date: Nov. 7, 2024

(54) STATION SIDE OPTICAL LINE TERMINATION APPARATUS, INFORMATION PROCESSING METHOD, AND PROGRAM

(71) Applicant: NIPPON TELEGRAPH AND TELEPHONE CORPORATION, Tokyo (JP)

(72) Inventors: Hiroshi OIWA, Musashino-shi, Tokyo (JP); Hiroshi YOSHIDA, Musashino-shi, Tokyo (JP)

(73) Assignee: NIPPON TELEGRAPH AND TELEPHONE CORPORATION, Tokyo (JP)

(21) Appl. No.: 18/565,553

(22) PCT Filed: Jun. 3, 2021
(86) PCT No.: PCT/JP2021/021219

§ 371 Date: Nov. 30, 2023

(51) Int. Cl. H04Q 11/00

(52) U.S. Cl. CPC H04Q 11/0067; H04Q 2011/0081

(57) ABSTRACT

According to an aspect of the present invention, a station side optical line terminal includes: a generation unit configured to generate backup data of setting data that defines an operation of the station side optical line terminal connected to a plurality of subscriber side optical line terminals in an optical access network; a division unit configured to divide the backup data to generate a plurality of backup data fragments; and a transmission unit configured to transmit the plurality of backup data fragments to the plurality of subscriber side optical line terminals.

### TECHNICAL FIELD

Embodiments of the present invention described herein relate generally to a station side optical line terminal, an information processing method, and a program.

### BACKGROUND ART

As one of optical access networks, a passive optical network (PON) in which an optical line terminal (OLT) serving as a station side optical line terminal and a plurality of optical network units (ONUs) serving as subscriber side optical line terminals are connected via an optical distribution network (ODN) is known (see, for example, Non Patent Literature 1).

An OLT includes a semiconductor component such as an application specific integrated circuit (ASIC) and operates by registering setting data necessary for a memory or the like included in the semiconductor component. The setting data may be damaged or lost due to a failure of a semiconductor component, occurrence of a software error, or the like.

In the related art, a maintenance person generates a backup of setting data in advance and stores the backup in an external device in order to restore the setting data. When the setting data is damaged or lost, the maintenance person restores the setting data using the backup data stored in the external device. As described above, to restore the setting data, an operation of a person is required.

### CITATION LIST

### Non Patent Literature

Non Patent Literature 1: “Technology Basic Course GE-PON Technology, 4th GE-PON Systematization Functions”, NTT Technical Journal pp. 59-61, November 2005

### SUMMARY OF INVENTION

### Technical Problem

An object of the present invention is to provide a technology enabling automatic restoration of setting data in a station side optical line terminal.

### Solution to Problem

According to an aspect of the present invention, a station side optical line terminal includes: a generation unit configured to generate backup data of setting data that defines an operation of the station side optical line terminal connected to a plurality of subscriber side optical line terminals in an optical access network; a division unit configured to divide the backup data to generate a plurality of backup data fragments; and a transmission unit configured to transmit the plurality of backup data fragments to the plurality of subscriber side optical line terminals.

### Advantageous Effects of Invention

According to the present invention, it is possible to provide a technology enabling automatic restoration of setting data in a station side optical line terminal.

### BRIEF DESCRIPTION OF DRAWINGS

FIG. 1 is a block diagram illustrating a communication system according to an embodiment of the present invention.

FIG. 2 is a block diagram illustrating a configuration of an OLT illustrated in FIG. 1.

FIG. 3 is a block diagram illustrating a hardware configuration of the OLT illustrated in FIG. 1.

FIG. 4 is a block diagram illustrating a configuration of an ONU illustrated in FIG. 1.

FIG. 5 is a block diagram illustrating a hardware configuration of the ONU illustrated in FIG. 1.

FIG. 6 is a flowchart illustrating a setting data backup method executed by the OLT illustrated in FIG. 1.

FIG. 7 is a flowchart illustrating an example of a setting data restoring method executed by the OLT illustrated in FIG. 1.

FIG. 8 is a flowchart illustrating another example of a setting data restoring method executed by the OLT illustrated in FIG. 1.

### DESCRIPTION OF EMBODIMENTS

Hereinafter, an embodiment of the present invention will be described with reference to the drawings. In order to avoid repeated description, the same constituents are denoted by the same reference numerals throughout the drawings. In order to identify the constituents, sub-numbers are added to the reference numerals.

### [Configuration]

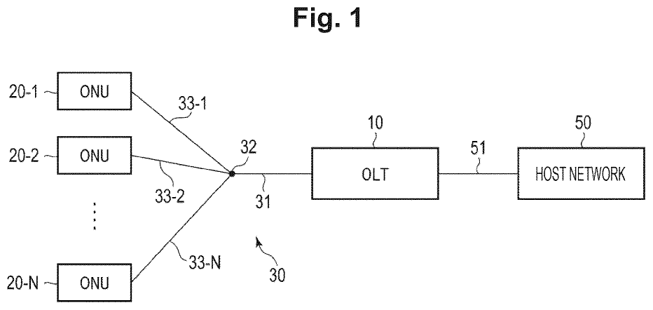

FIG. 1 schematically shows a communications system according to an embodiment of the present invention. The communications system shown in FIG. 1 includes a passive optical network (PON) 40 and a host network 50. The host network 50 can include, for example, the Internet. Here, the terms “system” and “network” may be used interchangeably.

The PON 40 is a point-to-multipoint optical access network. The PON 40 includes an optical line terminal (OLT) 10 serving as a station side optical line terminal and optical network units (ONUs) 20-1 to 20-N serving as subscriber side optical line terminal. The OLT 10 is connected to the ONUs 20-1 to 20-N via an optical distribution network (ODN) 30. Here, N is an integer equal to or greater than 2. For example, the OLT 10 is disposed in a facility of a service provider such as a telecommunication carrier, and an ONU 20 is disposed in a facility of a subscriber (for example, a house or an office building).

The ODN 30 includes an optical fiber cable 31, an optical splitter 32 which is a passive element, and optical fiber cables 33-1 to 33-N. The OLT 10 is connected to the ONUs 20-1 to 20-N via the optical fiber cable 31, the optical splitter 32, and the optical fiber cables 33-1 to 33-N. For example, the OLT 10 is connected to an ONU 20-1 via the optical fiber cable 31, the optical splitter 32, and an optical fiber cable 33-i. Here, i is an integer from 1 to N. The optical fiber cable 31 is shared by the ONUs 20-1 to 20-N.

The optical splitter 32 is configured to demultiplex an optical signal input from the optical fiber cable 31 into the optical fiber cables 33-1 to 33-N. The optical signal transmitted by the OLT 10 is branched by the optical splitter 32 and reaches the ONUs 20-1 to 20-N. Therefore, all the ONUs 20-1 to 20-N receive the same optical signal. The optical splitter 32 is further configured to multiplex the optical signals input from the optical fiber cables 33-1 to 33-N into the optical fiber cable 31.

In the above-described network configuration, the ONUs 20-1 to 20-N cannot communicate with each other.

A time division multiplexing (TDM) technology is used for downlink communication, and a time division multiple access (TDMA) technology is used for uplink communication. The downlink communication refers to communication from the OLT 10 to each ONU 20, and the uplink communication refers to communication from each ONU 20 to the OLT 10.

The OLT 10 is connected to the host network 50 via the optical fiber cable 51. The OLT 10 relays communication between each ONU 20 and the host network 50. Specifically, the OLT 10 transfers data from the ONU 20 to the host network 50. The OLT 10 transfers data from the host network 50 to the ONU 20.

Each ONU 20 is connected to a user network. The user network includes a user terminal such as a personal computer (PC) or a smartphone. The ONU 20 relays communication between the user network and the OLT 10. Specifically, the ONU 20 transfers the data from the OLT 10 to the user network. The ONU 20 transfers data from the user network to the OLT 10. The ONU 20 can communicate with the host network 50 via the OLT 10, but cannot communicate with the other ONUs 20.

Setting data necessary for an operation of the OLT 10 is registered in the OLT 10, and the OLT 10 operates according to the setting data. The OLT 10 distributes and arranges backup data of the setting data to the plurality of ONUs 20. Specifically, the OLT 10 divides the backup data to generate a plurality of backup data fragments and transmits the plurality of backup data fragments to the plurality of ONUs 20. When the setting data is damaged or lost in the OLT 10, the OLT 10 collects the plurality of backup data fragments from the plurality of ONUs 20 and combines the backup data fragments to restore the setting data.

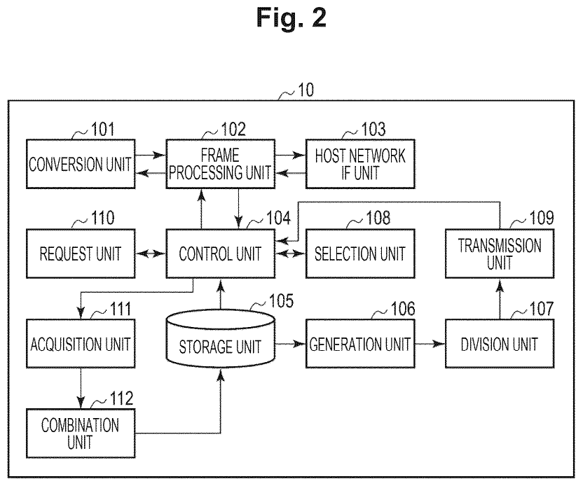

FIG. 2 schematically illustrates a configuration example of the OLT 10. As illustrated in FIG. 2, the OLT 10 includes a conversion unit 101, a frame processing unit 102, a host network interface (IF) unit 103, a control unit 104, a storage unit 105, a generation unit 106, a division unit 107, a selection unit 108, a transmission unit 109, a request unit 110, an acquisition unit 111, and a combination unit 112.

The storage unit 105 stores setting data that defines an operation of the OLT 10. The control unit 104 controls the operation of the OLT 10 according to the setting data stored in the storage unit 105. Further, the control unit 104 performs various processes such as a process of establishing a logical link between the OLT 10 and the ONU 20. For example, the control unit 104 allocates an identifier called a logical link identifier (LLID) to the ONU 20 during a process of establishing a logical link with the ONU 20. After the logical link between the OLT 10 and the ONU 20 is established, data frames can be exchanged between the OLT 10 and the ONU 20. The data frame is a frame including data transmitted from the user network to the host network 50 or data transmitted from the host network 50 to the user network.

The conversion unit 101 receives an uplink signal that is an optical signal from the ONU 20, performs optical-to-electrical conversion on the uplink signal, and sends the uplink signal to the frame processing unit 102. The conversion unit 101 receives a downlink signal that is an electrical signal from the frame processing unit 102, performs electrical-to-optical conversion on the downlink signal, and transmits the downlink signal to the ONU 20.

The frame processing unit 102 receives the uplink signal from conversion unit 101, and separates the uplink signal into a data frame and a control frame. The frame processing unit 102 transmits the data frame to host network IF unit 103, and transmits the control frame to the control unit 104. The control frame is a signal related to a PON protocol, and is used for negotiation between the OLT 10 and the ONU 20, and the like.

The frame processing unit 102 multiplexes the data frame received from the host network IF unit 103 and the control frame received from the control unit 104, and transmits the multiplexed data frame and control frame to the conversion unit 101 as a downlink signal. The frame processing unit 102 assigns a destination LLID and a transmission source LLID to each frame. For example, the frame processing unit 102 assigns the LLID allocated to the ONU 20 of the destination as a destination LLID and assigns the LLID of the OLT 10 as a transmission source LLID. As the LLID of the OLT 10, for example, the MAC address of the OLT 10 can be used.

The host network IF unit 103 receives the data frame from the frame processing unit 102, performs electrical-to-optical conversion on the data frame, and transmits the data frame to the host network 50. Further, the host network IF unit 103 receives a data frame that is an optical signal from the host network 50, performs optical-to-electrical conversion on the data frame to obtain a data frame, and sends the data frame to the frame processing unit 102.

In the present embodiment, optical communication is used for communication between the OLT 10 and the host network 50. In other embodiments, telecommunication may be used for communication between the OLT 10 and the host network 50.

The generation unit 106 generates backup data of the setting data. Specifically, the generation unit 106 duplicates the setting data stored in the storage unit 105 to generate backup data.

The division unit 107 divides the backup data to generate a plurality of backup data fragments. The division unit 107 may add an error correction code to the backup data and then divide the backup data. Alternatively, the division unit 107 may add an error correction code to the individual backup data fragments.

The selection unit 108 selects a plurality of ONUs 20 serving as storage destinations of a plurality of backup data fragments from the ONUs 20-1 to 20-N. The selection unit 108 may select a plurality of ONUs 20 serving as storage destinations from the ONUs 20-1 to 20-N based on distances between the OLT 10 and the ONUs 20-1 to 20-N. The distance between the OLT 10 and each ONU 20 can be measured by the control unit 104. The selection unit 108 may select a plurality of ONUs 20 serving as storage destinations from the ONUs 20-1 to 20-N such that a plurality of backup data fragments is geographically distributed. For example, the selection unit 108 groups the ONUs 20 based on the distances between the OLT 10 and the ONUs 20 and selects the ONU 20 so that backup data fragments are arranged in two or more groups. In other words, all the backup data fragments are not stored in the ONUs 20 belonging to the same group.

The transmission unit 109 transmits a plurality of backup data fragments to the plurality of ONUs 20. Specifically, the transmission unit 109 transmits a plurality of control frames each including a plurality of backup data fragments generated by the division unit 107 to the ONU 20 selected by the selection unit 108.

The request unit 110 requests backup data fragments from the plurality of ONUs 20. For example, the request unit 110 transmits a backup data request frame that is a control frame for request the plurality of ONUs 20 serving as the storage destinations of the backup data fragments to transmit the backup data fragments in response to the detection of the damage or the loss of the setting data by the control unit 104.

The acquisition unit 111 acquires the plurality of backup data fragments from the plurality of ONUs 20. Specifically, the acquisition unit 111 receives a control frame including the backup data fragments from each ONU 20.

The combination unit 112 combines the plurality of backup data fragments acquired by the acquisition unit 111 to restore the setting data. The combination unit 112 stores the restored setting data in the storage unit 105. The combination unit 112 may perform error detection and error correction on the restored setting data. Alternatively, the combination unit 112 may perform error detection and error correction on the individual backup data fragments, and subsequently combine the backup data fragments.

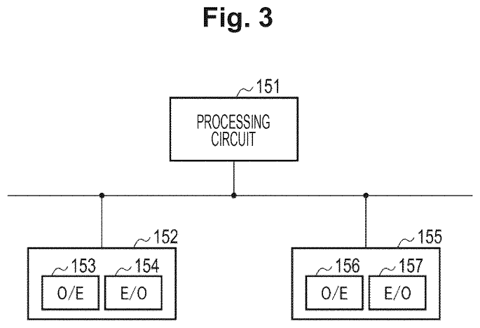

FIG. 3 schematically illustrates a hardware configuration example of the OLT 10. As illustrated in FIG. 3, the OLT 10 includes a processing circuit 151, a communication IF 152, and a communication IF 155 as hardware constituents. The frame processing unit 102, the control unit 104, the generation unit 106, the division unit 107, the selection unit 108, the transmission unit 109, the request unit 110, the acquisition unit 111, and the combination unit 112 illustrated in FIG. 2 are implemented by the processing circuit 151. The conversion unit 201 illustrated in FIG. 2 is implemented by the communication IF 152. The user network IF unit 203 illustrated in FIG. 2 is implemented by the communication IF 155.

The processing circuit 151 may be a dedicated circuit such as an ASIC or a field programmable gate array (FPGA). The dedicated circuit is connected to the memory. The memory may be provided inside the dedicated circuit or may be provided outside of the dedicated circuit. The memory stores data such as setting data.

The processing circuit 151 may include a general-purpose circuit and a memory instead of or in addition to the dedicated circuit. As the general-purpose circuit, for example, a central processing unit (CPU) can be used. The memory records data such as a control program and setting data. When the control program is executed by the general-purpose circuit, the control program causes the general-purpose circuit to perform at least some of the processes described with respect to the frame processing unit 102, the control unit 104, the generation unit 106, the division unit 107, the selection unit 108, the transmission unit 109, the request unit 110, the acquisition unit 111, and the combination unit 112 illustrated in FIG. 2.

The program may be supplied to the OLT 10 in a state of being stored in a computer-readable recording medium. In this case, the OLT 10 includes a drive that reads data from a recording medium and acquires a program from the recording medium. Examples of the recording medium include a magnetic disk, an optical disk (a CD-ROM, a CD-R, a DVD-ROM, a DVD-R, or the like), a magneto-optical disc (such as an MO), and a semiconductor memory. The programs may also be distributed via a network. Specifically, the program may be stored in a server on the network, and the OLT 10 may download the program from the server.

The communication IF 152 is an interface for communicating with the ONU 20. The communication IF 152 includes an optical-to-electrical (O/E) converter 153 that converts an optical signal into an electrical signal and an electrical-to-optical (E/O) converter 154 that converts an electrical signal into an optical signal. The communication IF 155 is an interface for communicating with the host network 50. The communication IF 155 includes an O/E converter 156 and an E/O converter 157.

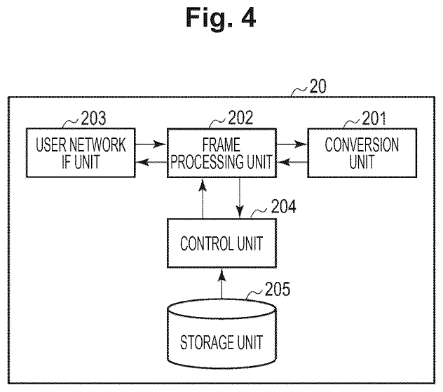

FIG. 4 schematically illustrates a configuration example of the ONU 20. The ONU 20 illustrated in FIG. 4 corresponds to one or each of the ONUs 20-1 to 20-N illustrated in FIG. 1. As illustrated in FIG. 4, the ONU 20 includes a conversion unit 201, a frame processing unit 202, a user network IF unit 203, a control unit 204, and a storage unit 205.

The conversion unit 201 receives a downlink signal that is an optical signal from the OLT 10, performs optical-to-electrical conversion on the downlink signal, and sends the downlink signal to the frame processing unit 202. The conversion unit 201 receives an uplink signal that is an electrical signal from the frame processing unit 202, performs electrical-to-optical conversion on the uplink signal, and transmits the uplink signal to the OLT 10.

The frame processing unit 202 receives the downlink signal from conversion unit 201, and separates the downlink signal into a data frame and a control frame. The frame processing unit 202 sends the data frame to user network IF unit 203, and sends the control frame to control unit 204. The frame processing unit 202 determines whether the destination of each frame is the own ONU 20 based on the destination LLID included in each frame. When the destination of the frame is the own ONU 20, the frame processing unit 202 sends the frame to the user network or the control unit 204. When the destination of the frame is not the own ONU 20, the frame processing unit 202 discards the frame.

The frame processing unit 202 multiplexes the data frame received from user network IF unit 203 and the control frame received from control unit 204, and transmits the multiplexed data frame and control frame to the conversion unit 201 as an uplink signal. The frame processing unit 202 assigns a destination LLID and a transmission source LLID to each frame. For example, the frame processing unit 202 assigns the LLID of the OLE 10 as the destination LLID and assigns the LLID allocated to the own ONU 20 as the transmission source LLID.

The user network IF unit 203 receives the data frame from the frame processing unit 202 and transmits the data frame to the user network. Further, the user network IF unit 203 receives the data frame from the user network and sends the data frame to the frame processing unit 202.

The control unit 204 controls an operation of the ONU 20. Further, the control unit 204 performs various processes such as a process of establishing a logical link between the OLT 10 and the ONU 20. For example, the control unit 204 receives a control frame including the backup data fragments from the OLT 10 and stores the backup data fragments in the storage unit 205. When the backup data request frame from the OLT 10 is received, the control unit 204 reads the backup data fragments from the storage unit 205 and transmits the control frame including the backup data fragments to the OLT 10.

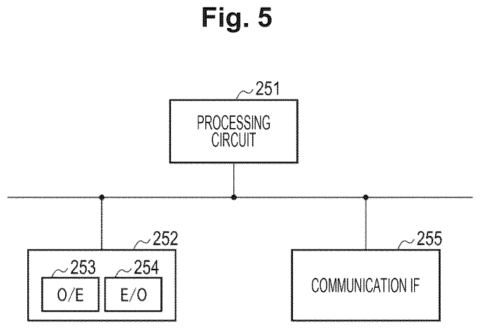

FIG. 5 schematically illustrates a hardware configuration example of the ONU 20. As illustrated in FIG. 5, the ONU 20 includes a processing circuit 251, a communication IF 252, and a communication IF 255 as hardware constituents. The frame processing unit 202 and the control unit 204 illustrated in FIG. 4 are implemented by the processing circuit 251. The conversion unit 201 illustrated in FIG. 4 is implemented by the communication IF 252. The user network IF unit 203 illustrated in FIG. 4 is implemented by the communication IF 255.

The processing circuit 251 may be a dedicated circuit such as an ASIC or an FPGA. The dedicated circuit is connected to the memory. The memory may be provided inside the dedicated circuit or may be provided outside of the dedicated circuit. The memory stores data such as backup data fragments.

The processing circuit 251 may include a general-purpose circuit and a memory instead of or in addition to the dedicated circuit. As the general-purpose circuit, for example, a CPU can be used. The memory records data such as a control program and backup data fragments. When the control program is executed by the general-purpose circuit, the control program causes the general-purpose circuit to perform at least some of the processes described with respect to the frame processing unit 202 and the control unit 204.

The communication IF 252 is an interface for communicating with the OLT 10. The communication IF 252 includes an O/E converter 253 and an E/O converter 254. The communication IF 255 is an interface for communicating with a user network. For example, the communication IF 255 includes a transmission/reception circuit conforming to a local area network (LAN) standard and a terminal for connecting a LAN cable.

### [Operation]

Next, an operation of the OLT 10 will be described.

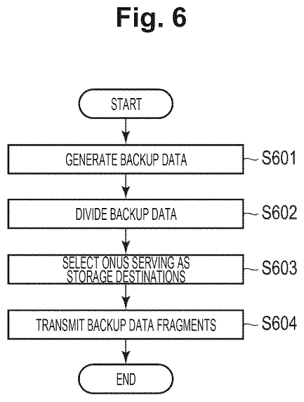

FIG. 6 schematically illustrates a setting data backup method executed by the OLT 10.

In step S601 of FIG. 6, the generation unit 106 generates backup data of the setting data that defines the operation of the OLT 10. For example, the generation unit 106 generates the backup data by duplicating the setting data.

In step S602, the division unit 107 divides the backup data generated by the generation unit 106 to generate a plurality of backup data fragments. For example, the division unit 107 adds an error correction code to the backup data and then divides the backup data.

In step S603, the selection unit 108 selects a plurality of ONUs 20 serving as storage destinations of the plurality of backup data fragments generated by the division unit 107 from the ONUs 20. The selection unit 108 may classify the ONUs 20 into a plurality of groups based on distances between the OLT 10 and the ONUs 20 and one or more predetermined distance thresholds. For example, the selection unit 108 classifies the ONUs 20 with which the distances are less than a first distance threshold to a first group, classifies the ONUs 20 with which the distances are equal to or greater than the first distance threshold and less than a second distance threshold to a second group, and classifies the ONUs 20 with which the distances are equal to or greater than the second distance threshold and less than a third distance threshold to a third group. The selection unit 108 may select one or more ONUs 20 from each group. The selection unit 108 may select a plurality of ONUs 20 so that ONUs 20 with which the distance differences exceed a predetermined threshold are included. For example, when the selection unit 108 selects a plurality of ONUs 20 including first and second ONUs 20, and a distance between the OLT 10 and the first ONU 20 is defined as a first distance, and a distance between the OLT 10 and the second ONU 20 is defined as a second distance, a difference between the first distance and the second distance exceeds a predetermined threshold value.

In step S604, the transmission unit 109 transmits the plurality of backup data fragments generated by the division unit 107 to the plurality of ONUs 20 selected by the selection unit 108.

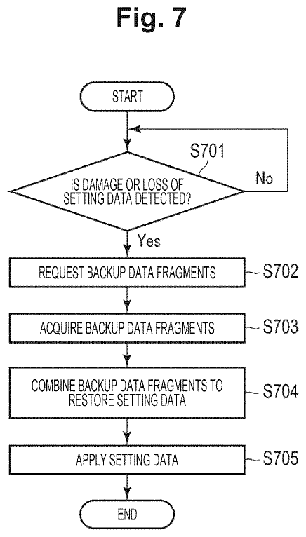

FIG. 7 schematically illustrates an example of a setting data restoring method executed by the OLT 10. The flow illustrated in FIG. 7 is executed after the flow illustrated in FIG. 6 is executed. In other words, when the flow illustrated in FIG. 7 is executed, the backup data fragments are stored in the ONU 20.

In step S701 of FIG. 7, detection of damage or loss of the setting data is performed. When the control unit 104 detects the damage or the loss of the setting data (Yes in step S701), the flow proceeds to step S702.

In step S702, the request unit 110 requests the ONU 20 in which the backup data fragment is stored to transmit the backup data fragments. For example, the request unit 110 transmits a backup data request frame to the ONU 20.

In step S703, the acquisition unit 111 acquires the backup data fragments from the ONU 20. For example, when the backup data request frames are received from the OLT 10, the control unit 204 of each ONU 20 reads the backup data fragments from the storage unit 205 and transmits a control frame including the backup data fragments to the OLT 10. The acquisition unit 111 receives the control frame from the ONU 20 and extracts the backup data fragments from the control frame.

In step S704, the combination unit 112 combines the backup data fragments acquired by the acquisition unit 111 to restore the setting data. The combination unit 112 may perform error detection and error correction on the restored setting data.

In step S705, the control unit 104 applies the setting data restored by the combination unit 112. For example, the combination unit 112 stores the setting data in the storage unit 105, and the control unit 104 performs control in accordance with the setting data stored in the storage unit 105.

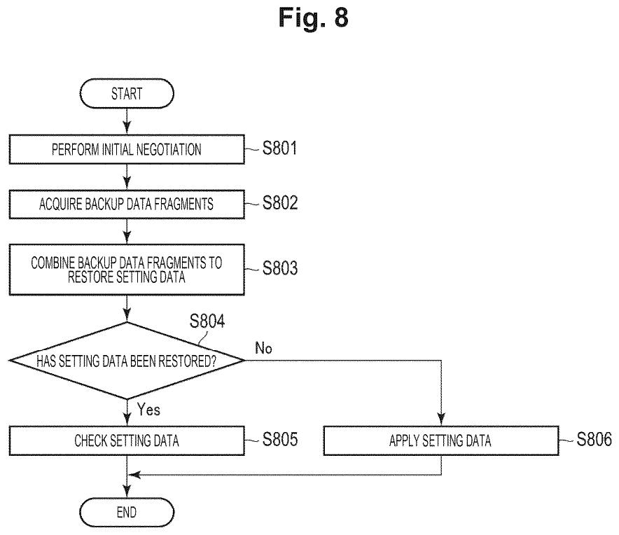

FIG. 8 schematically illustrates another example of the setting data restoring method executed by the OLT 10. The flow illustrated in FIG. 8 is executed by the new OLT 10 when the OLT 10 is replaced on the station side after the flow illustrated in FIG. 6 is executed. The ONU 20 detects that the OLT 10 has been replaced based on the control frame received from the OLT 10. For example, when it is detected that the transmission source LLID included in the control frame has changed, the ONU 20 determines that the OLT 10 has been replaced.

In step S801 of FIG. 8, the control unit 104 performs initial negotiation to establish a logical link with each ONU 20. When the OLT 10 is replaced, the new OLT 10 performs initial negotiation for all the connected ONUs 20 (for example, the ONUs 20-1 to 20-N illustrated in FIG. 1).

A sequence in which a logical link between the OLT 10 and the ONU 20 is established may include the following steps. First, when an unregistered ONU 20 has been found, the OLT 10 transmits a DiscoveryGATE frame for giving a notification of a transmission timing. When the DiscoveryGATE frame is received, the ONU 20 transmits a RegisterRequest frame for giving a request for registration to the OLT 10 in accordance with the transmission timing of which the notification is given with the DiscoveryGATE frame. When the RegisterRequest frame is received, the OLT 10 determines the LLID to be allocated to the ONU 20. The OLT 10 transmits a Register frame for giving a notification of the LLID to the ONU 20. Subsequently, the OLT 10 transmits a GATE frame for giving a notification of the transmission band and the transmission timing to the ONU 20. When the GATE frame is received, the ONU 20 transmits a RegisterACK frame which is a reception response of the Register frame to the OLT 10 in accordance with the transmission band and the transmission timing of which the notification is given with the GATE frame. As a result, the logical link is established.

In step S802, the acquisition unit 111 receives the plurality of backup data fragments from the plurality of ONUs 20. Each of the ONUs 20 keeping the backup data fragments receives the DiscoveryGATE frame, recognizes that the LLID of the transmission source included in the DiscoveryGATE frame is different from the previous LLID, and determines that the OLT 10 has been replaced. The ONU 20 transmits the backup data fragments in the control frame (for example, a RegisterRequest frame or a RegisterACK frame) transmitted to the OLT 10 in the sequence of establishing the logical link. The ONU 20 may transmit the backup data fragments in the control frame transmitted after the logical link is established. The acquisition unit 111 acquires the backup data fragments from the control frame received from the ONU 20.

In step S803, the combination unit 112 combines the plurality of backup data fragments acquired by the acquisition unit 111 to restore the setting data.

In step S804, the control unit 104 determines whether the setting data has been restored. For example, when the setting data is stored in the storage unit 105, the control unit 104 determines that the setting data has been restored. Otherwise, the control unit 104 determines that the setting data has not been restored.

When the setting data has been restored (Yes in step S804), the control unit 104 compares the setting data restored by the combination unit 112 with the setting data stored in the storage unit 105 and checks whether there is a difference between the pieces of setting data in step S805. As a result, it can be checked whether the restoration of the setting data has been correctly performed.

When the setting data has not been restored (No in step S804), the control unit 104 applies the setting data restored by the combination unit 112 in step S806. For example, the combination unit 112 stores the setting data in the storage unit 105, and the control unit 104 performs control in accordance with the setting data stored in the storage unit 105.

In the flow illustrated in FIG. 8, the ONU 20 actively supplies the backup data fragments to the OLE 10.

### Advantageous Effects

The OLT 10 generates backup data of setting data that defines an operation of the OLT 10, divides the backup data to generate a plurality of backup data fragments, and transmits the plurality of backup data fragments to the plurality of ONUs 20. The OLT 10 can collect the backup data fragments from the ONU 20 and restore the setting data from the collected backup data fragments. As described above, the backup data fragments are distributed and arranged in the ONU 20, which enables automatic restoration of the setting data in the OLT 10. Further, since the ONU 20 only keeps the backup data fragments, the entire setting data cannot be reproduced in the outside. As a result, it is possible to securely back up the setting data.

The OLT 10 acquires a plurality of backup data fragments from a plurality of ONUs 20 and combines the plurality of acquired backup data fragments to restore the setting data. For example, the OLT 10 may request the plurality of ONUs 20 to transmit the backup data fragments in response to detection of damage or loss of the setting data. The OLT 10 may obtain the plurality of backup data fragments from a control signal transmitted by the ONU 20 in a sequence in which a logical link between the OLT 10 and the ONU 20 is established. As a result, the setting data can be automatically restored in the OLT 10.

The OLT 10 selects an ONU 20 serving as a backup data fragment storage destination from the ONUs 20 based on the distance between the OLT 10 and the ONU 20. For example, in the OLT 10, the selection unit may classify the ONUs 20 into a plurality of groups including the first group and the second group based on the distances between the OLT 10 and the ONUs 20, and select at least one ONU 20 from the ONUs 20 belonging to the first group and at least one ONU 20 from the ONUs 20 belonging to the second group as the storage destinations of the backup data fragments. Accordingly, it is possible to geographically distribute the backup data fragments. As a result, the setting data can be backed up with higher security. For example, a malicious ONU is likely to transmit forged backup data fragments. By taking measures so that all the backup data fragments are not stored only in the ONUs 20 of which the distances are similar, data can be prevented from being supplied from malicious ONUs. The geographical separation of the ONUs 20 means distribution of users. Accordingly, there is less room for data from a malicious user to enter. As a result, security is enhanced.

The present invention is not limited to the foregoing embodiments, and various modifications can be made in an implementation stage without departing from the gist of the present invention. The embodiments may be implemented in appropriate combinations, and combined advantageous effects in these cases can be obtained. Further, the foregoing embodiments includes various inventions, and various inventions can be extracted by a combination selected from a plurality of disclosed constituents. For example, when the problems can be solved and the advantageous effects can be obtained even if some constituents are deleted from all the constituents described in the embodiment, configurations from which the constituents are deleted can be extracted as the inventions.

Reference Signs List

| | |
|---|---|
| 10 | Optical line terminal (OLT) |
| 20 | Optical network unit (ONU) |
| 30 | Optical distribution network (ODN) |
| 31, 33 | Optical fiber cable |
| 32 | Optical splitter |
| 50 | Host network |
| 51 | Optical fiber cable |
| 101 | Conversion unit |
| 102 | Frame processing unit |
| 103 | Host network interface unit |
| 104 | Control unit |
| 105 | Storage unit |
| 106 | Generation unit |
| 107 | Division unit |
| 108 | Selection unit |
| 109 | Transmission unit |
| 110 | Request unit |
| 111 | Acquisition unit |
| 112 | Combination unit |
| 151 | Processing circuit |
| 152, 155 | Communication interface |
| 153, 156 | Optical-to-electrical converter |
| 154, 157 | Electrical-to-optical converter |
| 201 | Conversion unit |
| 202 | Frame processing unit |
| 203 | User network interface unit |
| 204 | Control unit |
| 205 | Storage unit |
| 251 | Processing circuit |
| 253 | Optical-to-electrical converter |
| 254 | Electrical-to-optical converter |
| 252, 255 | Communication interface |

1. A station side optical line terminal for use in an optical access network in which the station side optical line terminal is connected to a plurality of subscriber side optical line terminals, the station side optical line terminal comprising:
generation circuitry configured to generate backup data of setting data that defines an operation of the station side optical line terminal;
division circuitry configured to divide the backup data to generate a plurality of backup data fragments; and
a transmitter configured to transmit the plurality of backup data fragments to the plurality of subscriber side optical line terminals.

2. The station side optical line terminal according to claim 1, further comprising:
selection circuitry configured to select a plurality of subscriber side optical line terminals from the plurality of subscriber side optical line terminals based on distances between the plurality of subscriber side optical line terminals and the station side optical line terminal,
wherein the transmitter transmits the plurality of backup data fragments to the plurality of selected subscriber side optical line terminals.

3. The station side optical line terminal according to claim 2, wherein:
the selection circuitry classifies the plurality of subscriber side optical line terminals into a plurality of groups including a first group and a second group based on the distances between the plurality of subscriber side optical line terminals and the station side optical line terminal, and selects at least one subscriber side optical line terminal included in the first group and at least one subscriber side optical line terminal included in the second group.

4. The station side optical line terminal according to claim 1, further comprising:
acquisition circuitry configured to acquire the plurality of backup data fragments from the plurality of subscriber side optical line terminals; and
combination circuitry configured to combine the plurality of acquired backup data fragments to restore the setting data.

5. The station side optical line terminal according to claim 4, further comprising:
control circuitry configured to detect damage or loss of the setting data; and
request circuitry configured to request the plurality of subscriber side optical line terminals to transmit the backup data fragments in response to the detection of the damage or the loss of the setting data.

6. The station side optical line terminal according to claim 4, wherein;
the acquisition circuitry acquires the plurality of backup data fragments from control signals transmitted by the plurality of subscriber side optical line terminals during sequences for establishing logical links between the station side optical line terminal and the plurality of subscriber side optical line terminals.

7. An information processing method, comprising:
generating backup data of setting data that defines an operation of a station side optical line terminal;
dividing the backup data to generate a plurality of backup data fragments; and
transmitting the plurality of backup data fragments to a plurality of subscriber side optical line terminals.

8. A non-transitory computer readable medium storing a program which when executed causes a computer to perform the method of claim 7.
